(19) United States
(12) Patent Application Publication
(10) Pub. No.: US 2002/0092609 A1
(43) Pub. Date: Jul. 18, 2002

(54) Seaming of solid surfacing veneers

(76) Inventor: Steven J. Moore, Temple, TX (US)

Correspondence Address: WILSONART INTERNATIONAL INC, C/O WELSH & FLAXMAN, LLC, 2341 JEFFERSON DAVIS HIGHWAY, SUITE 112, ARLINGTON, VA, 22202, US

(21) Appl. No.: 09/758,160

(22) Filed: Jan. 12, 2001

(51) Int. Cl. B32B 31/00

(52) U.S. Cl. 156/257

(57) ABSTRACT

A seaming method for bonding adjacent sheets of solid surfacing veneer. The method is achieved by forming a first tongue in an edge of a first sheet of solid surfacing veneer and forming a second tongue in an edge of a second sheet of solid surfacing veneer. The second tongue is shaped and dimensioned for mating with the first tongue of the first sheet of solid surfacing veneer. The first sheet of the solid surfacing veneer is then bonded to a substrate such that the first tongue is located at a predetermined position adjacent the location of a desired seam area. The second tongue is mated with the first tongue along the desired seam and the second sheet of solid surfacing veneer is bonded to both the first tongue and the substrate. A solid surfacing structure manufactured in accordance with the method is also described.

### BACKGROUND OF THE INVENTION

1. Field of the Invention

The invention relates to the seaming of solid surfacing veneers (SSV). More particularly, the invention relates to a system for constructing seams in the manufacture of SSV by providing the edges of adjacent sheets with mating tongue members.

2. Description of the Prior Art

Solid surfacing materials have become a popular replacement for natural materials, such as, marble and granite. Solid surfacing materials offer an appearance resembling natural materials without the shortcomings associated with the natural materials. Solid surfacing materials are commonly manufactured with a uniform composition throughout and offer many advantages not found in other materials. For example, solid surfacing materials are generally nonporous, scratch and crack resistant, tough and renewable.

Although multiple sheets of solid surfacing material may be combined to form a surface, solid surfacing materials are often fabricated without the resulting visible seams found in both resin impregnated decorative laminates and natural materials. Where distinct solid surfacing materials meet, the seam is generally filled with a color matched adhesive and the surrounding area is polished to remove any indication that distinct solid surfacing materials meet at the area in question.

A similar technique is employed where a gouge, or scratch, is found in the solid surfacing material. Specifically, the gouge is filled with a matching solid surfacing material and the surrounding area is polished to remove any indication that the solid surfacing material has been repaired at the area in question.

While solid surfacing materials offer many advantages, these materials are very expensive. The expense is generally associated with the cost of manufacturing the solid surfacing material itself and the difficulties associated with fabricating countertops, tabletops and other objects manufactured from the solid surfacing materials.

Attempts have been made to reduce the expense of using solid surfacing materials. For example, Wilsonart International, Inc. has developed solid surfacing veneers in which a solid surfacing material is bonded to a substrate. By manufacturing a thinner solid surfacing material (0.3175 cm as opposed to standard 1.27 cm) and bonding the solid surfacing material to a substrate, the cost of fabricating objects from solid surfacing materials has been substantially reduced. Solid surfacing veneers provide a reduction in the cost of materials, as well as a reduction in the fabrication costs commonly associated with solid surfacing materials, without sacrificing the many benefits offered by the solid surfacing materials.

The solid surfacing thermoplastic materials used in the manufacture of solid surfacing veneers, are cast and ideally suited as countertop base materials exhibiting scratch resistance, hardness, renewability and machinability. The term “machinability” is used to denote the ability of the thermoplastic acrylic sheet to be machined with conventional high pressure decorative laminate equipment. The term “renewability” is used to denote the ability to remove scratches and other marks on the surface of the thermoplastic acrylic sheet by sanding. Proper sanding of a scratched surface results in a surface containing no readily visible marks without the need for replacement or extensive repairs.

As mentioned above, it is sometimes necessary to seam adjacent sheets of the SSV in much the same manner as traditional solid surfacing materials. However, the reduced thickness of the SSV sheets, when compared to the traditional solid surfacing sheets, requires that new techniques be implemented in forming a seam between adjacent SSV sheets.

To date, and with reference to FIG. 1, adjacent sheets of SSV 10, 12 are commonly bonded along a seam 14 by positioning a bonding sheet 16 beneath the SSV sheets 10, 12, bonding the bonding sheet 16 to the substrate 18 and subsequently bonding the adjacent SSV sheets 10, 12 to the bonding sheet 16. The use of the bonding sheet 16 adds to the structural stability of the assembled structure, but necessitates the inclusion of additional materials and steps in the fabrication process. Specifically, the bonding sheet 16 holds the adjacent sheets of SSV 10, 12 along the seam 14 despite the different thermal coefficients of the SSV 10, 12 and substrate 18. The inclusion of the bonding sheets 16 unfortunately requires that a recess be cut in the substrate and that the bonding sheet be secured to the substrate prior to assembly of the SSV sheets 10, 12.

While this technique produces a secure bonding structure, the multiple steps add considerable time (and expense) to the fabrication process. As such, a need exists for an improved seaming technique. The present invention provides such an improved seaming system.

### SUMMARY OF THE INVENTION

It is, therefore, an object of the present invention to provide a seaming method for bonding adjacent sheets of solid surfacing veneer. The method is achieved by forming a first tongue in an edge of a first sheet of solid surfacing veneer and forming a second tongue in an edge of a second sheet of solid surfacing veneer. The second tongue is shaped and dimensioned for mating with the first tongue of the first sheet of solid surfacing veneer. The first sheet of the solid surfacing veneer is then bonded to a substrate such that the first tongue is located at a predetermined position adjacent a desired seam area. The second tongue is mated with the first tongue along the desired seam and the second sheet of solid surfacing veneer is bonded to both the first tongue and the substrate.

It is further an object of the present invention to provide a solid surfacing structure including a substrate offering a desired rigidity, a first sheet of solid surfacing veneer bonded to the substrate and a second sheet of solid surfacing veneer. The first sheet of solid surfacing veneer includes a first edge having a first tongue formed therein and the second sheet of solid surfacing veneer includes a first edge having a second tongue shaped and dimensioned for mating with the first tongue. The second tongue is matingly bonded with the first tongue and the remainder of the second sheet of solid surfacing veneer is bonded to the substrate.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a cross sectional view of a seam in accordance with the prior art.

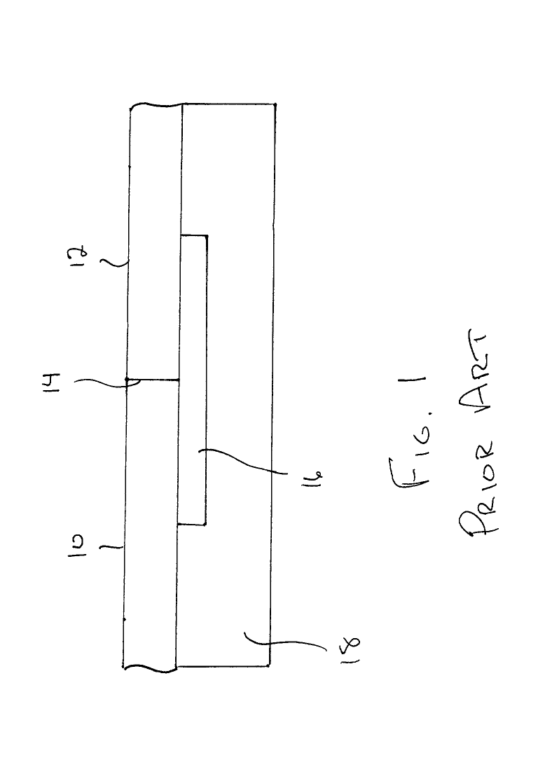

FIG. 2 is a cross sectional view of a seam in accordance with the present invention.

### DESCRIPTION OF THE PREFERRED EMBODIMENT

The detailed embodiment of the present invention is disclosed herein. It should be understood, however, that the disclosed embodiment is merely exemplary of the invention, which may be embodied in various forms. Therefore, the details disclosed herein are not to be interpreted as limited, but merely as the basis for the claims and as a basis for teaching one skilled in the art how to make and/or use the invention.

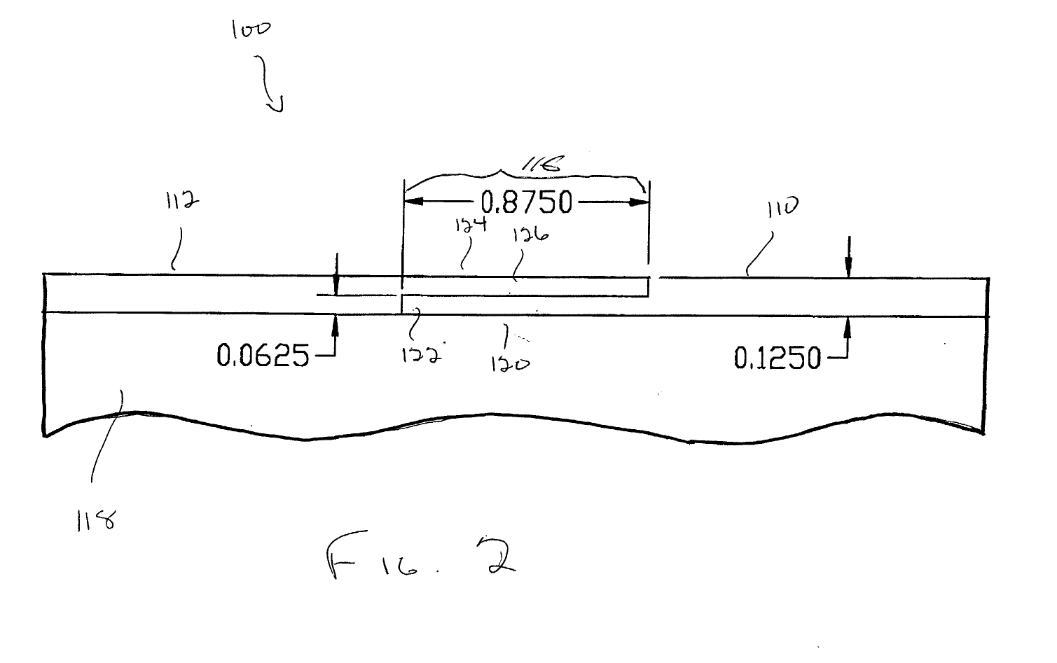

With reference to FIG. 2, a solid surfacing structure 100 formed of first and second sheets of solid surfacing veneer 110, 112 is disclosed. Briefly, the solid surfacing structure 100 includes a substrate 118, offering a desired rigidity, with first and second sheets of solid surfacing veneer 110, 112 bonded thereto. The first and second sheets of solid surfacing veneer 110, 112 are bonded to substrate along a seam area 116. For the purposes of the present description, the “seam area” is considered to be the predetermined location where the first and second sheets of solid surfacing veneer 110, 112 are joined together. In accordance with a preferred embodiment of the present invention, the substrate 118 is a traditional substrate used in the manufacture of decorative laminate panels. As such, it is contemplated that the substrate may be plywood, particleboard, chipboard, medium density fiberboard, etc.

The first sheet of solid surfacing veneer 110 is bonded to the substrate 118 along the predetermined seam area 116 and includes a first edge 120 having a first tongue 122 formed therein. The first tongue 122 is formed from a bottom portion of the first sheet of solid surfacing veneer 110. The second sheet of solid surfacing veneer 112 includes a first edge 124 having a second tongue 126 shaped and dimensioned for mating with the first tongue 122. The second tongue 126 is formed from an upper portion of the second sheet of the solid surfacing veneer 112. The second tongue 126 is matingly bonded with the first tongue 122 and the remainder of the second sheet of solid surfacing veneer 112 is bonded to the substrate 118. The respective tongues 122, 126 are shaped and dimensioned such that the upper surfaces of the first and second sheets of solid surfacing veneer 110, 112 are flush when bonded as discussed below.

Those skilled in the art will appreciate that the first and second solid surfacing veneers 110, 112 may be formed from a variety of solid surfacing materials within the spirit of the present invention, for example, solid surface materials as disclosed in commonly owned U.S. Pat. No. 5,5244,941, to Bruckbauer et al., entitled “Artificial Stone Compositions, Process Of Producing The Same, And Apparatus Employed In The Production Thereof”. In accordance with the present invention, the solid surfacing veneer takes the form of a thermoplastic acrylic sheet composition having a thickness of approximately 0.3175 cm. It is preferred that the acrylic sheet be translucent to provide the resulting product with an appearance of depth to the surface, similar to the appearance obtained with conventional 1.27 cm solid surfacing materials.

As mentioned above, the solid surfacing veneer of the present invention preferably provides scratch resistance, stain resistance, heat resistance and impact performance similar to or better than conventional solid surfacing materials. The preferred solid surfacing veneer also provides an aesthetically pleasing appearance and the ability to be post-formed without noticeable edge whitening. Solid surfacing veneers formed in accordance with the present invention can be used as a substitute for conventional high-pressure laminate and/or 1.27 cm solid surfacing materials in a variety of areas. These include, but are not limited to, countertops, vanity tops, bath and shower surrounds, furniture surfacing, wall surfacing, etc. For example, in the area of furniture surfacing, the present materials can be used to provide surfacing on tables, desks, chairs, file cabinets, etc. In fact, SSV provides the ability to offer all the advantages of solid surfacing technology at a fraction of the cost of conventional solid surfacing materials. In addition to offering the advantages of conventional solid surfacing materials, SSV offers all of the handling advantages of conventional high-pressure decorative laminate.

Assembly of the seam area 116 in accordance with the present invention is achieved in the following manner. Once the first and second sheets of solid surfacing veneer 110, 112 are formed, a first edge 120 of the first sheet of solid surfacing veneer 110 is machined to form a first tongue 122 along the first edge 120 of the first sheet of solid surfacing veneer 110. In accordance with a preferred embodiment of the present invention, the first tongue 120 is formed by machining a portion of the upper surface of the first sheet of solid surfacing veneer 110 along the first edge 120 to create an extension tongue of approximately 2.2225 cm in length and 0.15875 cm in thickness.

Similarly, a first edge 124 of the second sheet of solid surfacing veneer 112 is machined to form a second tongue 126 along the first edge 124 of the second solid surfacing veneer 112. In accordance with a preferred embodiment of the present invention, the second tongue 126 is formed by machining a portion of the bottom surface of the second sheet of solid surfacing veneer 112 to create an extension tongue 126 of approximately 2.2225 cm in length and 0.15875 cm in thickness. The second tongue 126 is shaped and dimensioned to mate with the first tongue 122 in such a way that the upper surface of both the first and second sheets of solid surfacing veneers 110, 112 align once the solid surfacing structure 100 is finally assembled in accordance with the present invention.

As those skilled in the art will readily appreciate, the disclosure above only discusses the machining of first edges on each of the solid surfacing veneers. However, those skilled in the art will readily appreciate, that multiple edges of a solid surfacing veneer may be machined as needed without departing from the spirit of the present invention.

In addition, a preferred tongue length is disclosed above in accordance with a preferred embodiment of the present invention. However, the tongue length may be varied so long as sufficient surface area is provided to produce a desired seam strength. With this in mind, it is contemplated that the tongues may vary in length from approximately 1.27 cm to 2.54 cm. It should also be noted that the specific thickness of the sheets reflects a preferred embodiment of the present invention, and variations in thickness may be applied without departing from the spirit of the present invention.

Once the first and second sheets of solid surfacing veneers 110, 112 are properly machined, the first sheet of the solid surfacing veneer 110 is bonded to a substrate 118 such that the first tongue 122 is located at a predetermined position adjacent the desired seam area 116. The second tongue 126 is then mated with the first tongue 122 along the desired seam area 116 and the second sheet of solid surfacing veneer 112 is bonded to both the first tongue 122 and the substrate 118. While the first sheet is first bonded to the substrate in accordance with a preferred embodiment of the present invention, it is contemplated that the first and second sheets may be mated, and adhesively bound, prior to bonding to the substrate. The mated first and second sheets would then be bonded to the substrate as a unit.

By bonding the first and second sheets of solid surfacing veneer 110, 112 along the first and second tongues 122, 126, bonding over sufficient surface area is provided to securely couple the first and second solid surfacing veneers 110, 112 along the seam area 116. This secure bond prevents separation which might be caused by thermal expansion/contraction, as well as other environmental conditions, without necessitating the additional steps and materials required in prior art seaming systems.

In accordance with a preferred embodiment of the present invention Wilsonart 8206 Adhesive or Wilsonart 8215 Adhesive are used to bond the solid surfacing veneers 110, 112 along the first and second tongues 122, 126. In addition, and in accordance with a preferred embodiment of the present invention, Wilsonart 3000 Adhesive is used in bonding the solid surfacing veneers 110, 112 to the substrate. While these specific adhesives and bonding techniques are disclosed in accordance with a preferred embodiment of the present invention, those of ordinary skill will appreciate the variety of bonding techniques which may be used in accordance with the present invention.

The adhesive used in bonding the tongues of the first and second solid surfacing veneers 110, 112 together is color matched to the solid surfacing veneers themselves. As such, and after the adhesive has fully set, the exposed portion 128 of the seam area 116 is polished to remove any indication that distinct solid surfacing materials meet at the area in question.

While the preferred embodiments have been shown and described, it will be understood that there is no intent to limit the invention by such disclosure, but rather, is intended to cover all modifications and alternate constructions falling within the spirit and scope of the invention as defined in the appended claims.

1. A seaming method for bonding adjacent sheets of solid surfacing veneer, comprising the following steps:
forming a first tongue in an edge of a first sheet of solid surfacing veneer;
forming a second tongue in an edge of a second sheet of solid surfacing veneer, the second tongue being shaped and dimensioned for mating with the first tongue of the first sheet of solid surfacing veneer;
bonding the first sheet of the solid surfacing veneer to a substrate such that the first tongue is located at a predetermined position adjacent a desired seam area;
mating the second tongue with the first tongue along the desired seam area; and
bonding the second sheet of solid surfacing veneer to both the first tongue and the substrate:

2. The method according to claim 1, wherein the step of forming a first tongue includes removing a portion of the upper surface of the solid surfacing veneer along the edge.

3. The method according to claim 2, wherein the upper surface is removed by machining in the first solid surfacing veneer.

4. The method according to claim 2, wherein the tongue is approximately 2.2225 cm in length.

5. The method according to claim 1, wherein the step of forming a second tongue includes removing a portion of the bottom surface of the second solid surfacing veneer along the edge.

6. The method according to claim 5, wherein the bottom surface is removed by machining the second solid surfacing veneer.

7. The method according to claim 5, wherein the tongue is approximately 2.2225 cm in length.

8. The method according to claim 1, wherein the solid surfacing veneer is a thermoplastic acrylic sheet.

9. The method according to claim 1, wherein the solid surfacing veneer has a thickness of approximately 0.3175 cm.

10. The method according to claim 1, wherein the substrate is chosen from the group consisting of plywood, particleboard, chipboard and medium density fiberboard.

11. A solid surfacing structure, comprising:
a substrate offering a desired rigidity;
a first sheet of solid surfacing veneer bonded to the substrate, the first sheet of solid surfacing veneer including a first edge having a first tongue formed therein;
a second sheet of solid surfacing veneer including a first edge having a second tongue shaped and dimensioned for mating with the first tongue, wherein the second tongue is matingly bonded with the first tongue and the remainder of the second sheet of solid surfacing veneer is bonded to the substrate.

12. The product according to claim 11, wherein the first tongue is formed from the bottom portion of the first solid surfacing veneer along the edge.

13. The product according to claim 12, wherein the first tongue is approximately 2.2225 cm in length.

14. The product according to claim 11, wherein the second tongue is formed from the upper portion of the second solid surfacing veneer along the edge.

15. The product according to claim 14, wherein the second tongue is approximately 2.2225 cm in length.

16. The product according to claim 11, wherein the solid surfacing veneer is a thermoplastic acrylic sheet.

17. The product according to claim 11, wherein the solid surfacing veneer has a thickness of approximately 0.3175 cm.

18. The product according to claim 11, wherein the substrate is chosen from the group consisting of plywood, particleboard, chipboard and medium density fiberboard.
